(19) United States
(12) Patent Application Publication
(10) Pub. No.: US 2010/0288129 A1
(43) Pub. Date: Nov. 18, 2010

(54) DEVICE FOR TREATING AND PURIFYING A LIQUID PRODUCT

(76) Inventors: Valeriy Evgenyevich Kisterev, Moscow (RU); Pavel Dmitrievich Zherdev, Moscow (RU)

Correspondence Address: Thomas M. Galgano, 20 W. Park Avenue, Suite 204, Long Beach, NY, 11561, US

(21) Appl. No.: 12/531,144

(22) PCT Filed: Mar. 6, 2008
(86) PCT No.: PCT/RU2008/000125

§ 371 Date: May 28, 2010

(30) Foreign Application Priority Data
Mar. 13, 2007 (RU) 2007109210

(51) Int. Cl. C12H 1/22

(52) U.S. Cl. 99/277.1

(57) ABSTRACT

The invention substantially relates to the distillery industry. The inventive device comprises a cartridge (3) with a filter and a body, which are secured on a bottle neck, and a manual pump (10) for supplying air inside the bottle

The device relates to the food industry, in particular to the distillery industry. The invention is intended for the individual treatment and purification of each portion of a liquid product (vodka) poured from the bottle (container) before its consumption by the consumer.

There exists a device for treatment and purification of liquid products (see U.S. Pat. No. 6,193,886 dated 27, Feb. 2001), containing a cartridge body connected with the neck of the bottle and filter located therein, and an air supply device.

The imperfection of the existing device is the low efficiency of the cartridge employed, caused by pushing through it of the liquid products with different levels of purification and the impossibility to use bottles with a rigid body.

The technical result achieved by this invention is the elimination of the said imperfection by creating a more comfortable and simple mechanism for provision of the required excess of the air pressure in the internal volume of the bottle with the liquid product and positioning of a filter throughout the cross section of the body of the cartridge.

The purpose of this invention is also to create a simple assembly to supply the pressurized external air into the internal volume of the vessel with a liquid.

The said result is achieved by fixing the filter above the maximum level of the liquid in a bottle, on the internal surface of the body of the device for treatment and purification of a liquid product, which contains a container, a cartridge, consisting of a body connected with the neck of the bottle and containing a filter, and an air supply device, and by that the air supply device includes a manual pump fixed on the bottle, connected with the tube which is connected with the air supply unit. The air supply unit may be formed by a tube and a through channel made in the body of the cartridge. Or by the sealing ring element placed between the body of the cartridge and the neck of the bottle, hermetically connected to the tube and with the channels made in the body of the cartridge on its internal surface and limited by the outer surface of the neck of the bottle. The body of the cartridge may be filled with the following sequentially placed filter components: rough filtering material; sorbent or a mixture thereof and fine filtering material. To prevent splashing, the outlet orifice of the body is fitted with a spreader. The assembly for connecting the body of the cartridge to the neck of the bottle may be made with a sealing holder in form of a ring lug on the internal surface of the body placement spot so as to fix it to a ring collar on the outer surface of the neck of the bottle. The cartridge is covered with the decorative cap connected to its body through a screw thread with a pilfer-proof cap or the aperture executed in a bottle tightly connected to a tube by means of tighting element. The body of the cartridge may be hermetically connected with the neck of the bottle by means of a placement spot with directional internal thread or fitting, i.e. with a connection, which ensures that on fitting the cartridge by a machine, it will always be fitted with the through channel to a specific place on the bottle. The air pump may be made in form of an empty vessel made of elastic airtight material with fitted inlet and outlet valves. The pump is fixed on the outer surface of the bottle.

The essence of the invention is illustrated by the drawings.

The drawing 1 schematically shows the device with air inlet channel in the body of the cartridge.

The drawing 2 shows the same with threaded fixation of the body of the cartridge.

The drawing 3 schematically shows the device with air supply unit in form of a ring sealing element.

The drawing 4 shows the same with threaded fixing of the body of the cartridge.

The drawing 5 shows the device with an aperture in the bottle case is schematically represented.

The drawing 6 shows the same with carving fastening of the case of a cartridge.

The device contains three main components besides the vessel: the treatment and purification assembly; the air supply device with a mechanism for formation of the excessive pressure inside the vessel and the air supply unit.

The treatment and processing assembly consists of: the decorative sealing cap 1 with internal thread 2 for screwing onto the body 3 of the cartridge; encapsulating element made of elastic plastic 4 in two versions of the device; the cartridge, whose body has a spot 5 for placement onto the neck of the bottle, the limitation spreader 6 with flow channels, the thread 2 on the outer side for screwing the sealing cap and a cavity, in which the rough filtering material 7, the sorbent 8 or a mixture thereof and the fine filtering material 9 are sequentially placed.

The air supply device with a mechanism for formation of the required pressure in the interior of the bottle consists of the vessel 10 made of elastic material with inlet 11 and outlet 12 valves, that is, a press air pump. The pump is located inside the bottle and organically fits the bottle configuration in accordance with the design of the product.

The air supply unit consists of: the air supply tube 13 and channel 14 in the body of the cartridge, hermetically connected to the tube. Through them the pressurized external air is supplied from the air pump through the release valve into the interior of the bottle 15.

The device described on the drawings 1 and 2 operates as follows.

A sealed bottle of vodka is taken in hands and opened by unscrewing the decorative cap 1 and is turned upside down over the drinking vessel. The vodka, contained in the bottle is poured through the orifice in the encapsulating element 4 to the rough filtering material 7, part thereof, under the effect of gravitational forces, passes through it and enters the space in the cartridge filled with sorbent 8 or a mixture thereof, which provide the required level of vodka treatment. Having passed through the sorbent 8, the vodka is unable to pass through the fine filtering material 9 by the mere action of the gravitational forced due to decrease of the air pressure in the interior of the bottle 15 due to the air inside becoming rarefied and due to a strong overall resistance of the filtering materials 7 and 9 and the sorbent 8. To push the vodka through the filtering materials and the sorbent, the consumer presses the vessel of the air pump, which has a large volume in its initial state. The inlet valve 11, under the effect of pressure inside the air pump vessel is closed and outlet valve 12 is opened, as a result of which, the air from the pump, through the tube 13, the air supply channel 14 in the body of the cartridge and the orifice in the encapsulating element, is supplied into the interior of the bottle. The user continues to press on the vessel of the air pump is continued till the pressure inside the bottle is sufficient to push the vodka through the filtering materials and the sorbent and until the required speed or pouring is achieved. Having filled the drinking vessel with the treated vodka, the consumer stops pressing the air pump vessel and turns the bottle with its neck up. The excessive air pressure in the bottle will push part of the vodka from the space filled with sorbent, through the filtering material 9 into the space in the body of the cartridge above it, limited by the restrictive spreader 6, while the residual pressure is released through the vodka flow channels in the restrictive spreader of the cartridge outside. The restrictive spreader configuration prevents vodka splashes produced by pressure release. The release valve shuts down, thus restricting the air access into the bottle. The decorative sealing cap is screwed onto the body of the cartridge using the threaded connection and encapsulates the bottle. The remaining vodka from the cartridge, under the effect of gravitational forces, gradually flows back into the bottle. The operation may be repeated as required.

The second example of the device implementation is shown on the drawings 3 and 4.

The air supply unit in the second version consists of: the air supply tube 13; the ring seal 16 and the air channels 17 connected with it. The channels are made in the elements of the internal surface of the body of the cartridge, along the external surface of the neck of the bottle 15, through which the pressurized external air from the vessel of the press air pump is supplied into the interior of the bottle 15.

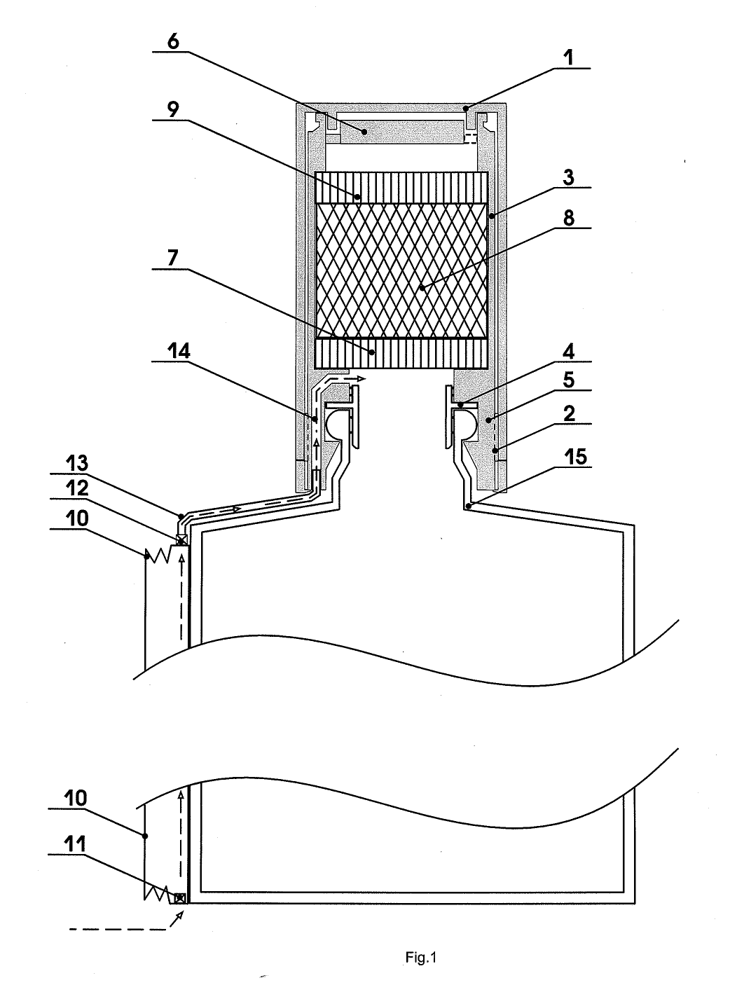

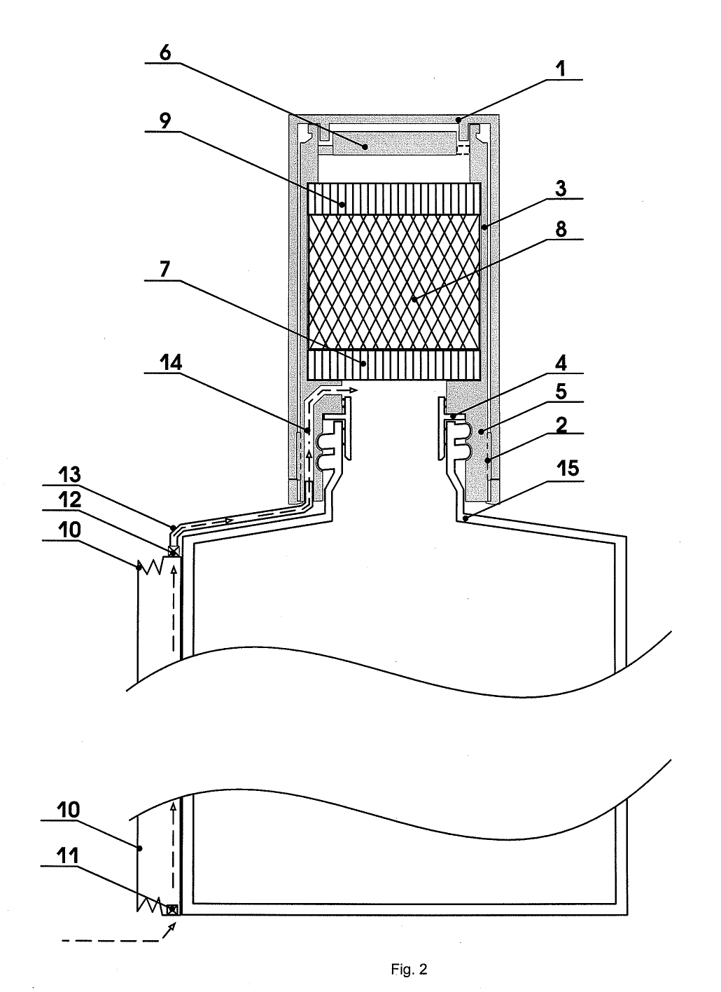

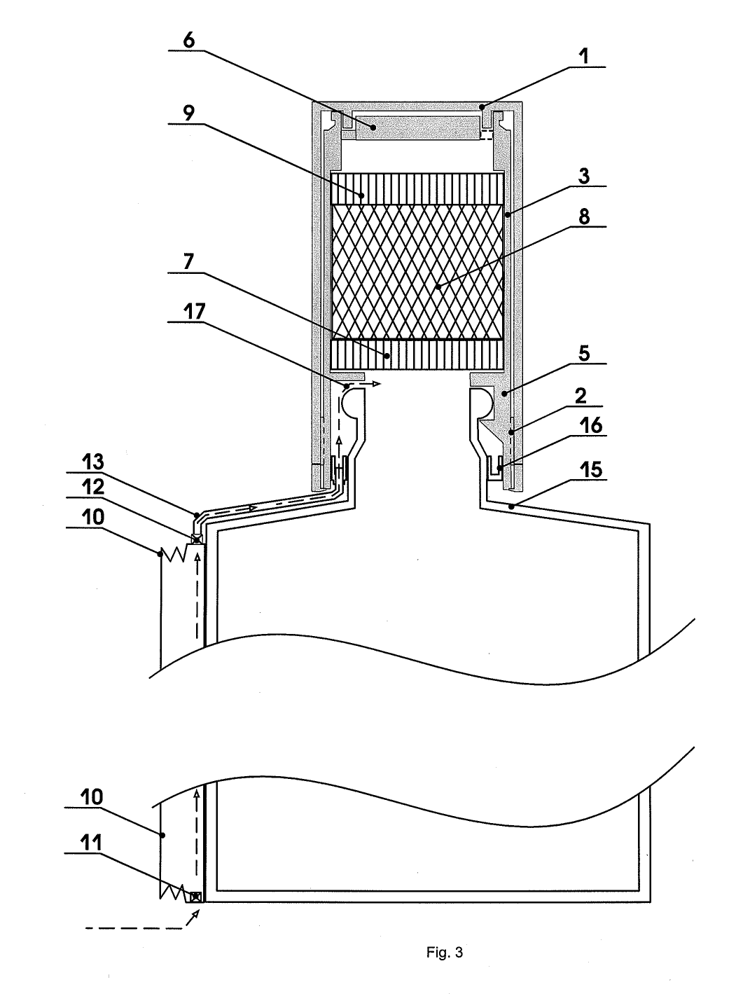

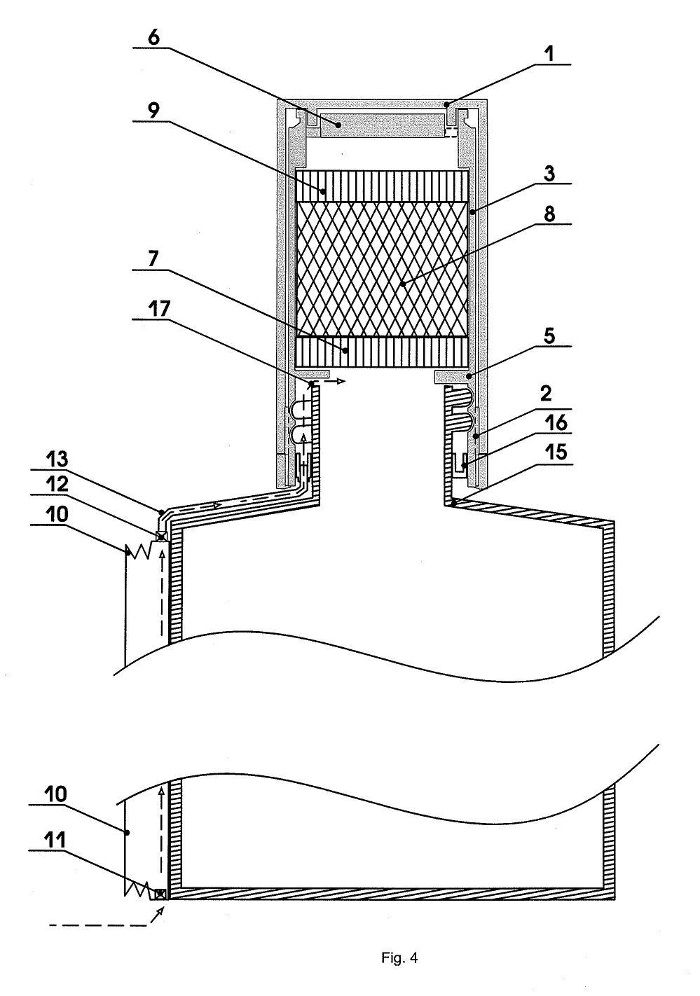

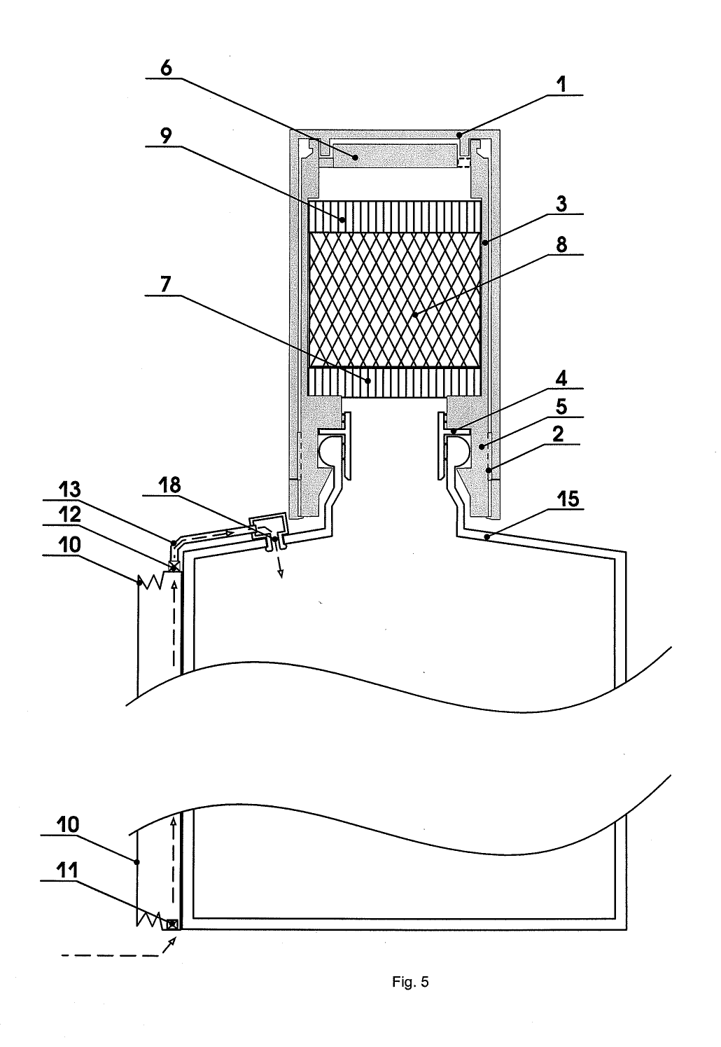

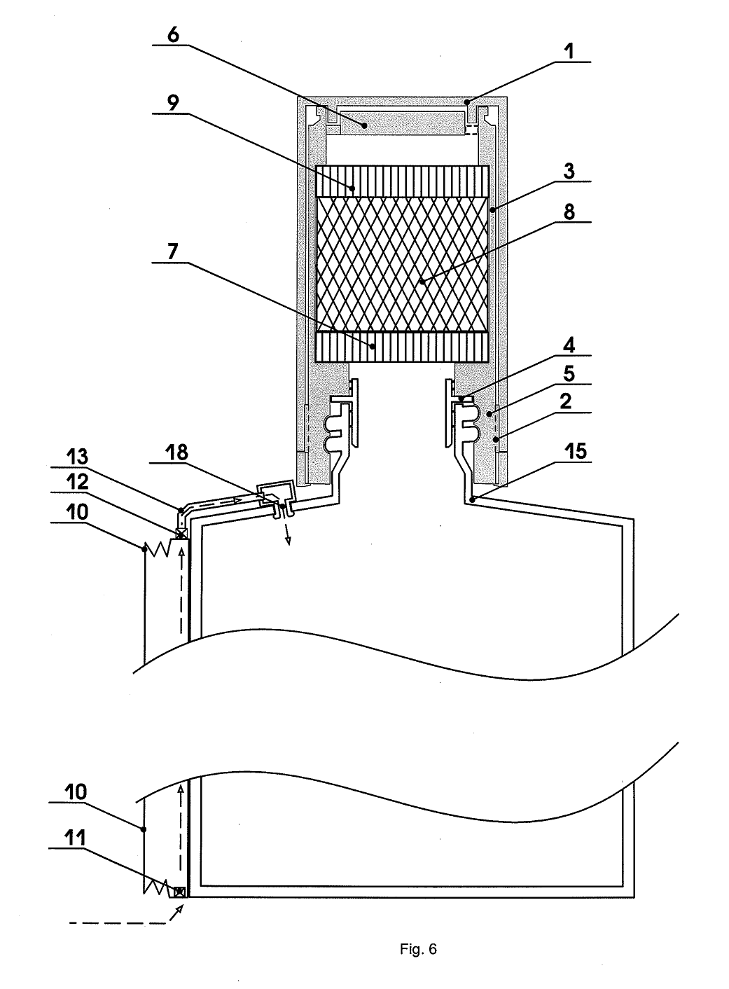

The device described on the drawings 3 and 4 is operated similarly to the first option.

<<The third example of performance of the device is presented on FIGS. 5 and 6.

The knot of giving of air in the third variant consists of specially organized aperture in a bottle tightly by means of the sealing element 18 connected to air-conducting 13 tube through which air of environment from capacity of the air press pump under pressure arrives in an internal cavity of a bottle 15.

Work of the device represented on FIGS. 5 and 6 it is carried out similarly to first two variants.>>

1. A device for the treatment and purification of a liquid product located in a bottle, containing a cartridge, comprising:
a body having an interior surface and which is connectable with a neck of a bottle and a filter located inside the body, and an air supply device, wherein the filter is fixed on the interior surface in the body, and the air supply device includes a hand air pump, connected with a tube, which is hermetically connected with a through channel made in the body of the cartridge or hermetically connected by means of a sealing element aligned with the channels made on the internal surface of the body of the cartridge and limited by the external surface of the neck of the bottle.

2. The device according to claim 1, wherein:
the filter is formed of a member selected from the group consisting of sequentially placed rough filtering material, sorbent and a mixture of rough filtering material, sorbent and a fine filtering material.

3. The device according to claim 1, wherein:
an outlet orifice on the body is fitted with a spreader.

4. The device according to claim 1, wherein:
the body of the cartridge is hermetically connected with the neck of the bottle using the placement spot with directional internal thread.

5. The device according to claim 1, wherein:
the body of the cartridge is hermetically connected with the neck of the bottle using the placement spot with a fitting.

6. The device according to claim 1, wherein:
the device to connect the body to the neck of the bottle is made in form of a lock holder

7. The device according to claim 1, wherein:
a decorative cap is hermetically fitted on the body.

8. The device according to claim 7, wherein:
the cap is fitted on the body using a thread with a pilfer-proof cap.

9. The device according to claim 1, wherein:
the hand air pump is made in form of an empty vessel made of elastic airtight material with embedded inlet and outlet valves, fixed on the external surface of the bottle.

10. (canceled)
